(19) United States
(12) Patent Application Publication
(10) Pub. No.: US 2026/0285651 A1
(43) Pub. Date: Sep. 24, 2026

(54) ANTI-LIFT SYSTEM OF CONTAINER TRUCK

(71) Applicant: MBE Co., Ltd., Siheung-si (KR)

(72) Inventors: Gi Yong PARK, Ansan-si (KR); Jong Sun LEE, Ansan-si (KR); Nam Hoon JUNG, Seoul (KR)

(73) Assignee: MBE Co., Ltd., Siheung-si (KR)

(21) Appl. No.: 19/403,274

(22) Filed: Nov. 28, 2025

(30) Foreign Application Priority Data
Mar. 21, 2025 (KR) 10-2025-0036380

(51) Int. Cl. B66C 15/06; B66C 13/46; B66C 13/48; G01S 17/86; G01S 17/88; B60P 1/64

(52) U.S. Cl. CPC B66C 15/065; B66C 13/46; B66C 13/48; G01S 17/86; G01S 17/88; B60P 1/6445

(57) ABSTRACT

The present disclosure relates to a system for preventing lifting of a container truck that may occur during a task of unloading a container therefrom using a crane apparatus, and an anti-lift system of a container truck according to the present disclosure includes a light detection and ranging (LIDAR) sensor that is installed on a ground surface and detects whether wheels of the container truck and the ground surface are spaced from each other and a LIDAR controller that processes a detection signal and determines whether the container truck is lifted, thereby preventing an accident that may occur while twist locks are not released and preventing damage to equipment and casualties.

### CROSS-REFERENCE TO RELATED APPLICATION(S)

This application claims priority from Korean Patent Application No. 10-2025-0036380, filed on March 21, 2025, in the Korean Intellectual Property Office, the disclosure of which is incorporated herein by reference in its entirety.

### BACKGROUND

### Field

The present disclosure discloses a crane system-related technology for loading and unloading containers to and from a truck on which the containers are mounted.

### Description of Related Art

Containers are very widely used due to having advantages of facilitating storage and transportation of goods, being able to be used repeatedly, not requiring re-loading during transportation, and facilitating transshipment between different means of transportation. Such containers are mostly transported by vehicles and ships and are stored in a container terminal, a container yard, a container depot, or the like. Crane apparatuses such as a rubber-tired container gantry crane (RTGC), a rail-mounted container gantry crane (RMGC), an overhead bridge crane (OBC), and a straddle carrier are used depending on a method of loading containers.

Generally, a container is moved to a crane apparatus while mounted on a truck, and the crane apparatus lifts the container and loads the container to a specific place. In a process in which a truck having a container mounted thereon moves to a crane apparatus, a plurality of twist locks are provided on the truck to prevent the container from being separated from the truck, the container is moved while fixed to the truck, and after the container reaches the crane apparatus, the twist locks are released, and then the crane apparatus lifts the container.

However, due to a mistake by a worker, a failure of the twist locks, etc., the crane apparatus sometimes attempts to lift a container while the twist locks are not released (locked). In this case, because the container and the truck are lifted together, serious problems may be caused, including not only economic loss due to damage to the crane apparatus, damage to the twist locks, damage to the container, etc., but also human loss due to an accident of a worker. Therefore, there is an urgent need for introducing a technology that can prevent a situation in which a container and a truck are lifted together and prevent economic and human losses.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present disclosure relates to a system for a safe unloading task of a container truck and is directed to preventing lifting of a container truck that may occur when a crane apparatus lifts a container while twist locks are not released.

Specifically, the present disclosure is directed to providing a light detection and ranging (LIDAR) sensor-based anti-lift system that can accurately detect whether wheels of a container truck and a ground surface are spaced from each other.

The present disclosure is also directed to preventing economic loss due to damage to a crane apparatus, a twist lock, a container, etc., and human loss due to an accident of a worker, etc. by immediately stopping an operation of the crane apparatus when lifting of a container truck is detected.

The present disclosure is also directed to providing a system with which a lifting situation can be visually monitored, thereby allowing a worker to clearly recognize the situation and appropriately handle the situation.

An anti-lift system of a container truck according to the present disclosure addresses the above objectives through the following configuration.

According to one aspect of the present disclosure, there is provided an anti-lift system of a container truck that is a system preventing lifting of a container truck when a container is lifted from a container truck, on which the container is mounted, using a crane system including a crane, the anti-lift system including a light detection and ranging (LIDAR) sensor that is installed on a ground surface, detects whether wheels of the container truck and the ground surface are spaced from each other, and generates a detection signal according thereto, and a LIDAR controller that receives the detection signal from the LIDAR sensor, processes the detection signal, and determines whether the container truck is lifted.

According to one embodiment of the present disclosure, the LIDAR sensor may accurately detect whether the wheels of the container truck and the ground surface are spaced from each other by performing scanning in a direction parallel to the ground surface. This enables more prompt and accurate detection compared to the conventional method of checking by visual inspection.

In addition, according to another embodiment of the present disclosure, the LIDAR sensor may accurately determine which part of the container truck is being lifted by further detecting whether a wheel spaced from the ground surface is at least any one of a front wheel and a back wheel. As a result, which of a plurality of twist locks has not been released can be accurately checked.

According to still another embodiment of the present disclosure, the LIDAR controller may three-dimensionally analyze a lifting state of the container truck by performing a process of generating a point cloud based on the detection signal received from the LIDAR sensor.

According to an additional embodiment of the present disclosure, the anti-lift system may further include a manager terminal, and upon detecting that lifting of the container truck has occurred, the LIDAR controller may transmit an alarm signal to the manager terminal and allow a worker to immediately recognize a situation in which the container truck is lifted.

According to yet another embodiment of the present disclosure, the crane system may further include a crane controller that controls a moving operation of the crane, and upon detecting that lifting of the container truck has occurred, the crane controller may provide a stop signal so that the moving operation of the crane is stopped to prevent an accident.

In addition, according to yet another embodiment of the present disclosure, the system may further include a camera that is disposed adjacent to the LIDAR sensor and captures an image of a side surface of the container truck, and the camera may provide image data of the side surface of the container truck to the manager terminal to allow the worker to visually check a situation.

Other features and aspects will be apparent from the following detailed description, the drawings, and the claims.

### BRIEF DESCRIPTION OF THE DRAWINGS

FIG. 1 is a front view for describing a conventional crane system in which a container is lifted from a container truck using a crane apparatus.

FIG. 2 is a side view for describing a situation in which a container and a container truck are lifted together by a crane apparatus while twist locks are not released.

FIG. 3 is a top view for describing an anti-lift system of a container truck according to one embodiment.

FIG. 4 is a side view for describing the anti-lift system of a container truck according to one embodiment.

FIG. 5 is a side view for describing the anti-lift system of a container truck that further includes a camera according to one embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The above-described and additional aspects are embodied through embodiments described herein with reference to the accompanying drawings. It should be understood that components of each embodiment may be combined in various ways within one embodiment or with components of another embodiment unless mentioned otherwise or contradictory to each other. Terms used in the present specification and the claims should be interpreted as having meanings and concepts consistent with the description or proposed technical spirit based on the principle that the inventor may appropriately define the concept of a term in order to describe his or her invention in the best possible way. Hereinafter, preferred embodiments of the present disclosure will be described in detail with reference to the accompanying drawings.

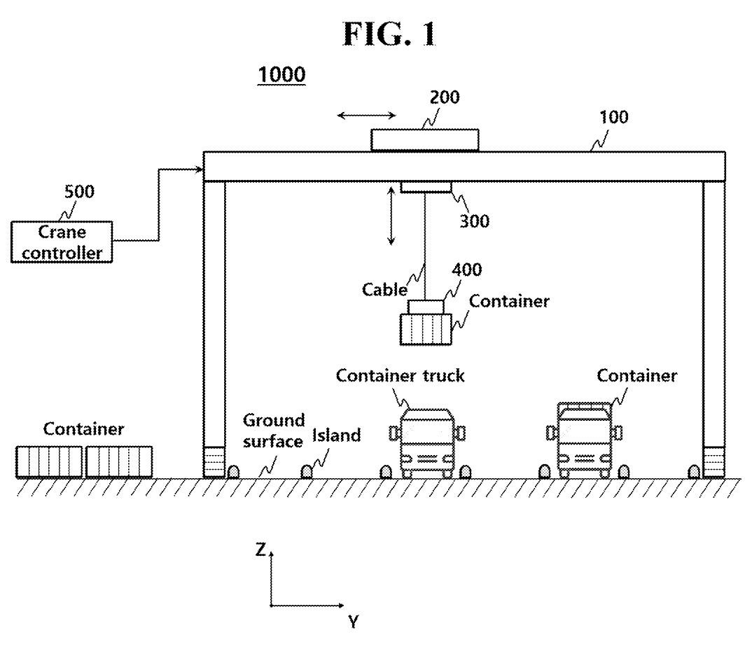

FIG. 1 is a front view for describing a crane system in which a container is lifted from a container truck using a conventional crane system 1000. Referring to FIG. 1, the crane system 1000 may include a gantry 100, a trolly 200, a hoist 300, a spreader 400, and a crane controller 500.

The gantry 100 is a frame structure of the crane system 1000 and is installed to be fixed to a container yard. The trolly 200 is installed at an upper portion of the gantry 100 and is movable in a left-right direction. The hoist 300 is connected to the trolly 200 and is movable in an up-down direction. The spreader 400 is a device that is connected to a lower portion of the hoist 300 to lift a container. The crane controller 500 controls operations of the gantry 100, the trolly 200, the hoist 300, and the spreader 400.

In a typical work process, when a container truck loaded with a container enters a lower portion of the crane system 1000, the spreader 400 is moved downward by the hoist 300, is coupled to the container, and lifts the container. In this process, twist locks installed on the container truck should be released for the container to be safely lifted.

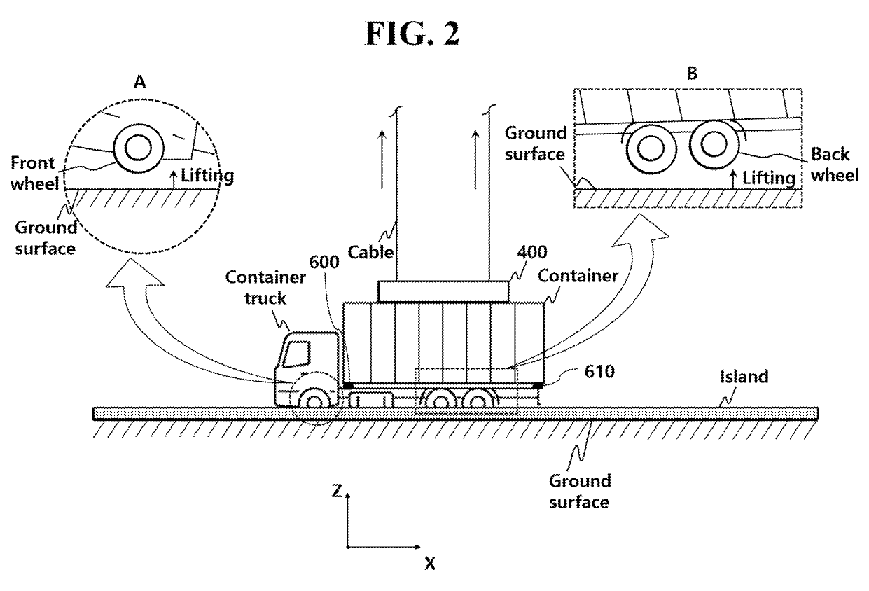

FIG. 2 is a side view for describing a situation in which a container and a container truck are lifted together by a crane while twist locks are not released. Referring to FIG. 2, a container mounted on a container truck is fixed to the container truck by a front end twist lock 600 and a back end twist lock 610. When the container is lifted by the crane apparatus while the twist locks 600 and 610 are not released, the container truck is lifted together due to the twist locks 600 and 610. Enlarged view A of FIG. 2 shows a situation in which front wheels are lifted from the ground surface, and Enlarged view B of FIG. 2 shows a situation in which back wheels are lifted from the ground surface. The twist locks 600 and 610 may be provided as a plurality of twist locks 600 and 610 on the container truck, and preferably, four or more twist locks may be provided for a twist lock to be provided on each edge of the truck. A wheel may include a tire. Front wheels may be lifted when the twist lock 600 is not completely released (see Enlarged view A), and back wheels may be lifted when the twist lock 610 is not completely released (see Enlarged view B).

The crane may be a rubber-tired container gantry crane (RTGC), but is not limited thereto. The crane system 1000 may include the crane controller 500, and the crane may be the crane system 1000 excluding the crane controller 500.

The situation in which the container truck is lifted may cause serious problems, including not only economic loss due to damage to the crane apparatus, damage to the twist locks, damage to the container, etc., but also human loss due to an accident of a worker. Therefore, the present disclosure provides an anti-lift system of a container truck for addressing such problems.

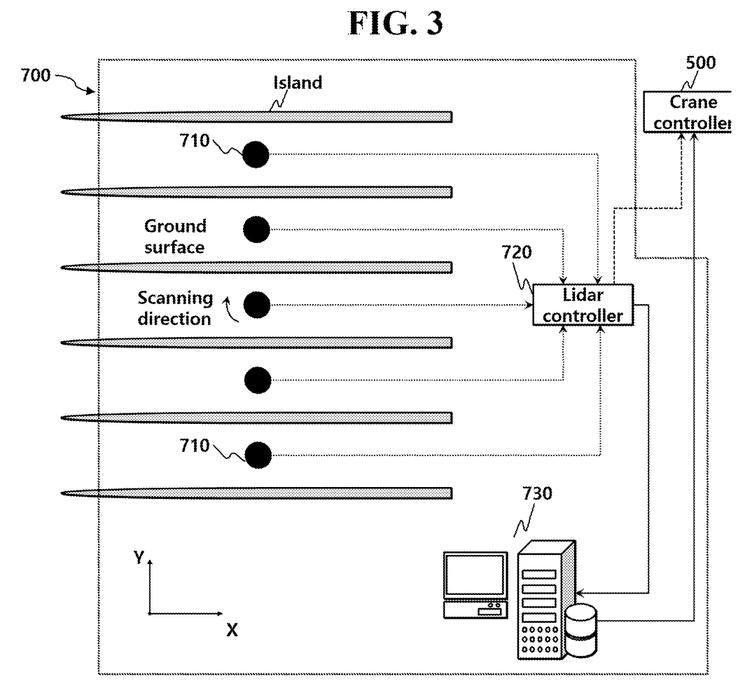

FIG. 3 is a top view for describing an anti-lift system 700 of a container truck according to one embodiment of the present disclosure. Referring to FIG. 3, the anti-lift system 700 of a container truck may include a plurality of light detection and ranging (LIDAR) sensors 710 and a LIDAR controller 720 and may further include a manager terminal 730 according to an additional aspect.

The LIDAR sensors 710 may be installed in between islands located at both sides of passages through which container trucks pass. The islands may serve as guide walls that guide a stopping position of a container truck and may also perform a function of supporting a specific article. The LIDAR sensors 710 may each have a substantially cylindrical shape. One or more LIDAR sensors 710 may be provided, and each LIDAR sensor 710 may consist of a light emitter that emits laser light of a specific frequency (e.g., 50 Hz) and a light receiver that receives reflected laser light.

According to one embodiment, the LIDAR sensors 710 may each perform scanning in a direction parallel to the ground surface and may detect whether wheels of a container truck and the ground surface are spaced from each other. The LIDAR sensors 710 having a cylindrical shape may be advantageous for thoroughly scanning the ground surface. The LIDAR sensors 710 utilize the time-of-flight principle in which a distance to an object is calculated by measuring the time taken for projected laser light to be reflected and return. If wheels of a container truck are spaced from the ground surface, the return of reflected light may be delayed, or the reflected light may not return, and using such a principle, whether the wheels of the container truck and the ground surface are spaced from each other may be detected.

The LIDAR controller 720 receives detection signals from the plurality of LIDAR sensors 710, processes the detection signals, and determines whether the container truck is lifted. The LIDAR controller 720 may generate a point cloud based on data received from the LIDAR sensors 710, may analyze the point cloud, and may accurately determine whether the wheels of the container truck are lifted from the ground surface. The point cloud may consist of 3D images, may include images of the islands, and may further include images of the wheels of the container truck.

The manager terminal 730 may be connected to the LIDAR controller 720, may visually display information on a lifting state of the container truck, and may provide an alarm to a worker when necessary. In addition, the LIDAR controller 720 may be connected to the crane controller 500 and may, when lifting of the container truck is detected, provide a signal for immediately stopping an operation of the crane. The manager terminal 730 may be a computer, a server, or a portable terminal having a monitor or a display.

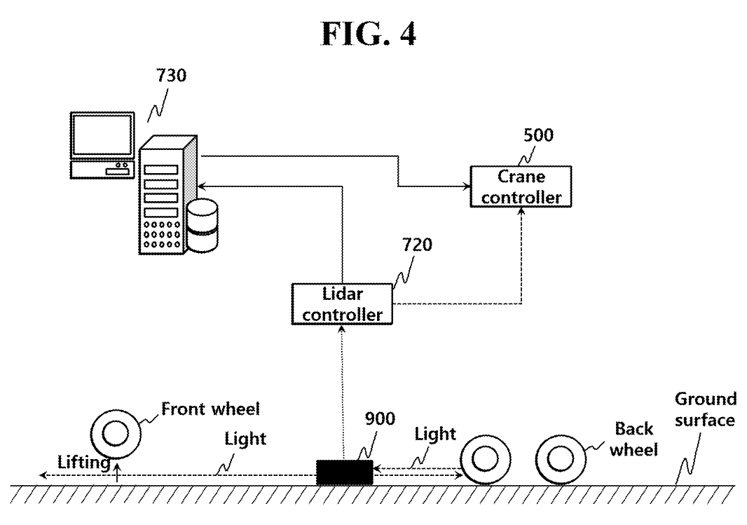

FIG. 4 is a side view for describing the anti-lift system of a container truck according to one embodiment of the present disclosure. Referring to FIG. 4, a LIDAR sensor 900 installed on the ground surface may emit laser light and may monitor a distance between the ground surface and front wheels and back wheels of the container truck. The LIDAR sensor 900 may immediately detect whether the wheels are lifted from the ground surface and may send this information to the LIDAR controller 720.

According to one embodiment, the LIDAR controller 720 processes data received from the LIDAR sensor 900, determines whether the container truck is lifted, and sends this information to the manager terminal 730 and the crane controller 500. When lifting of the container truck is detected, the crane controller 500 immediately stops the operation of the crane to prevent an additional accident. The crane controller 500 may be a programmable logic controller (PLC), and the PLC may be an industrial facility control device that logically and sequentially processes input values and controls various movements of a movable crane using output results.

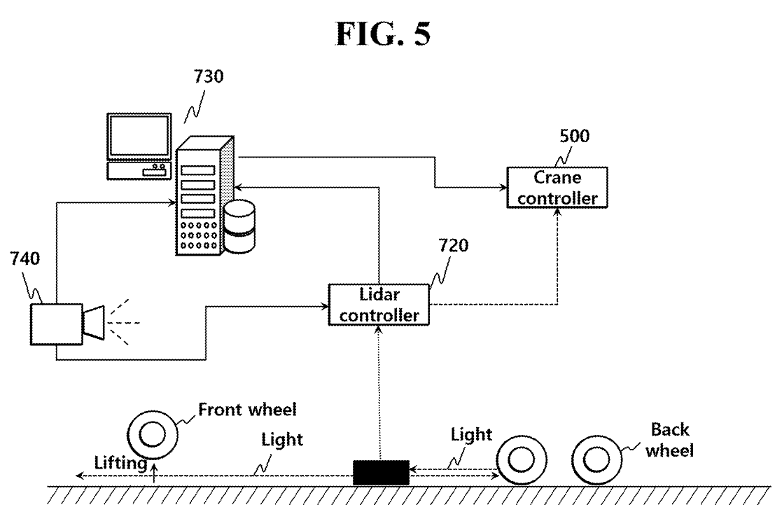

FIG. 5 is a side view for describing the anti-lift system of a container truck that further includes a camera 740 according to another embodiment of the present disclosure. Referring to FIG. 5, the camera 740 may be installed in the vicinity of the LIDAR sensor 900 and may capture an image of a side surface of a container truck. When lifting of the container truck is detected, the camera 740 may provide an image at the corresponding point in time to the manager terminal 730 to allow a worker to visually check the situation. The camera 740 may be electrically connected to the LIDAR controller 720 and may provide image data to the LIDAR controller 720.

According to one embodiment, a network video recorder (NVR) (not illustrated) may be further included between the camera 740 and the manager terminal 730 or the LIDAR controller 720. In this case, the camera 740 may be construed as including the NVR. In addition, a terminal operating system (TOS) (not illustrated) may be further included between the LIDAR controller 720 and the crane controller 500. In this case, the crane controller 500 may be construed as including the TOS.

In this way, the anti-lift system 700 of a container truck according to the present disclosure may accurately detect whether wheels of a container truck and the ground surface are spaced from each other by utilizing the LIDAR sensors 710 and may, when lifting of the container truck is detected, immediately stop the operation of the crane to prevent an additional accident. In addition, image data acquired through the camera 740 is provided to the manager terminal to provide support and allow a worker to visually check the situation and take direct action.

The anti-lift system 700 of a container truck according to the present disclosure detects in advance and prevents a dangerous situation in which a container truck is lifted together with a container while twist locks are not released, thereby preventing economic loss due to damage to the crane apparatus, damage to the twist locks, damage to the container, etc., and human loss due to an accident of a worker, etc.

According to the present disclosure, since lifting of a container truck can be accurately detected, and an appropriate action can be taken according thereto, it is possible to effectively prevent economic loss due to damage to a crane apparatus, a twist lock, a container, etc., and human loss due to an accident of a worker, etc.

Advantageous effects of the present disclosure are not limited to those mentioned above, and other unmentioned advantageous effects should be clearly understood by those of ordinary skill in the art to which the present disclosure pertains from the present specification and the accompanying drawings.

The present disclosure has been described above using embodiments with reference to the accompanying drawings, but the present disclosure is not limited thereto and should be construed as encompassing various modifications that may be self-evidently derived by those of ordinary skill in the art. The claims are intended to encompass such modifications.

Although all components constituting an embodiment of the present disclosure are described as being combined into one component or being combined into and operated as one component, the present disclosure is not necessarily limited to such an embodiment. That is, within the scope of the present disclosure, all of the components may be selectively combined into one or more components and operated.

What is claimed is:

1. An anti-lift system of a container truck that is a system preventing lifting of a container truck when a container is lifted from a container truck, on which the container is mounted, using a crane system including a crane, the anti-lift system comprising:
a light detection and ranging (LIDAR) sensor that is installed on a ground surface, detects whether wheels of the container truck and the ground surface are spaced from each other, and generates a detection signal according thereto; and
a LIDAR controller that receives the detection signal from the LIDAR sensor, processes the detection signal, and determines whether the container truck is lifted.

2. The anti-lift system of claim 1, wherein the LIDAR sensor performs scanning in a direction parallel to the ground surface.

3. The anti-lift system of claim 1, wherein the LIDAR sensor further detects whether a wheel spaced from the ground surface is at least any one of a front wheel and a back wheel.

4. The anti-lift system of claim 1, wherein the LIDAR controller performs a process of generating a point cloud based on the detection signal.

5. The anti-lift system of claim 1, further comprising a manager terminal,
wherein the LIDAR controller transmits an alarm signal to the manager terminal , upon detecting that lifting of the container truck has occurred.

6. The anti-lift system of claim 1, wherein:
the crane system further includes a crane controller that controls a moving operation of the crane; and
upon detecting that lifting of the container truck has occurred, the crane controller provides a stop signal so that the moving operation of the crane is stopped.

7. The anti-lift system of claim 5, further comprising a camera that is disposed adjacent to the LIDAR sensor and captures an image of a side surface of the container truck,
wherein the camera provides image data of the side surface of the container truck to the manager terminal.
